(19) United States
(12) Patent Application Publication
(10) Pub. No.: US 2017/0374162 A1
(43) Pub. Date: Dec. 28, 2017

(54) METHOD AND SYSTEM FOR REGISTERING PLURALITY OF DEVICES

(71) Applicant: S-PRINTING SOLUTION CO., LTD., Suwon-si (KR)

(72) Inventor: Jung-hun KIM, Suwon-si (KR)

(73) Assignee: S-PRINTING SOLUTION CO., LTD., Suwon-si (KR)

(21) Appl. No.: 15/630,253

(22) Filed: Jun. 22, 2017

(30) Foreign Application Priority Data
Jun. 27, 2016 (KR) 10-2016-0080238

(51) Int. Cl. H04L 29/08

(52) U.S. Cl. CPC H04L 67/16; H04L 67/2871

(57) ABSTRACT

A computer-implemented method includes receiving, at a server, device information of a plurality of devices, the device information being collected by an intermediate device, receiving, at the server, administrator information, and registering the plurality of devices to the server based on the received administrator information and the received device information. A system for registering the plurality of devices may implement the computer-implemented method.

### CROSS-REFERENCE TO RELATED APPLICATIONS

This application claims the priority benefit of Korean Patent Application No. 10-2016-0080238, filed on Jun. 27, 2016, in the Korean Intellectual Property Office, the disclosure of which is incorporated herein in its entirety by reference.

### BACKGROUND

### 1. Field

The disclosure relates to a method and system for registering a plurality of devices.

### 2. Description of the Related Art

As a cloud service is used in increasingly varied fields, the number of users of the cloud service is also increasing.

A user may register his devices to a provider server of the cloud service to use the cloud service. Each device may be registered to the server by directly accessing the server via each device. However, when the number of the devices exceeds a certain number or the devices are located in different places, it may be time consuming and increase network traffic to acquire authentication of all of the devices.

An image forming apparatus, such as a printer, a scanner, a copy machine, a facsimile machine, or a multi-function printer, may be provided with a communication interface such as Ethernet, Wi-Fi, Wi-Fi Direct, near field communication (NFC), Bluetooth, Zigbee, infrared data association (IrDA) to connect to other devices. The image forming apparatus may upload to and download from a cloud server a document by accessing the cloud server through the communication interface.

Generally, an image forming apparatus that is used in an office, institution, or school may be managed by an administrator. The image forming apparatus may be registered to a cloud server by the administrator. The administrator may register the image forming apparatus to the server by directly accessing the server via the image forming apparatus. However, when the number of image forming apparatuses exceeds a certain number or the apparatuses are located in different places, it may be time consuming and increase network traffic to access the server via each device.

### SUMMARY

Additional aspects and/or advantages will be set forth in part in the description which follows and, in part, will be apparent from the description, or may be learned by practice of the disclosure.

According to an example embodiment, a plurality of devices may be registered to a server simultaneously.

According to an example embodiment, a plurality of devices may be registered to a server through an intermediate device.

According to an example embodiment, a plurality of devices may be registered to a server through an intermediate device so that network traffic may be reduced.

Provided are a method, a system, and a computer-readable recording medium for registering a plurality of devices to a server.

According to an example embodiment, a computer-implemented method may include receiving, at a server, device information of a plurality of devices, the device information being collected by an intermediate device, receiving, at the server, administrator information, and registering the plurality of devices to the server based on the received administrator information and the received device information.

According to an example embodiment, the plurality of devices may be discovered by the intermediate device, and the device information may be collected by the intermediate device from the discovered plurality of devices.

According to an example embodiment, the computer-implemented method may further include transmitting a device search request to the intermediate device, and the plurality of devices may be discovered by the intermediate device receiving the transmitted device search request.

According to an example embodiment, the device information may be uploaded to the server by an administrator.

According to an example embodiment, the registering of the plurality of devices may include determining whether the plurality of devices are already registered to the server, and egistering to the server an unregistered device from among the plurality of devices based on the received administrator information and the received device information.

According to an example embodiment, the registering of the plurality of devices may include determining whether the plurality of devices are already registered to the server, and changing a registration status of a registered device from among the plurality of devices.

According to an example embodiment, the registering of the plurality of devices may include transmitting to the plurality of devices a registration request for registering the plurality of devices to the server based on the received administrator information and the received device information, receiving from the plurality of devices a registration response transmitted in response to the registration request, and registering the plurality of devices to the server based on the received registration response.

According to an example embodiment, at least one of the registration request and the registration response may be communicated by the intermediate device.

According to an example embodiment, a system may include a memory configured to store instructions, and at least one processor configured to execute the instructions to receive device information, collected by an intermediate device, of a plurality of devices, receive administrator information, and register the plurality of devices to the system based on the received administrator information and the received device information.

According to an example embodiment, the processor may be further configured to execute the instructions to transmit a device search request to the intermediate device, and the plurality of devices may be discovered by the intermediate device in response to the intermediate device receiving the transmitted device search request.

According to an example embodiment, the processor may be further configured to execute the instructions to determine whether the plurality of devices are already registered to the system, and register to the system an unregistered device among the plurality of devices based on the received administrator information and the received device information.

According to an example embodiment, the processor may be further configured to execute the instructions to determine whether the plurality of devices are already registered to the system, and change a registration status of a registered device among the plurality of devices.

According to an example embodiment, the processor may be further configured to execute the instructions to transmit to the plurality of devices a registration request for registering the plurality of devices to the system based on the received administrator information and the received device information, receive from the plurality of devices a registration response transmitted in response to the registration request, and register the plurality of devices to the system based on the received registration response.

According to an example embodiment, a non-transitory computer readable recording medium having recorded thereon instructions, which when executed by a processor, cause the processor to carry out the computer-implemented method.

According to an example embodiment, a non-transitory computer readable recording medium having thereon instructions, which when executed by a processor, may cause the processor to collect device information from a plurality of devices, and transmit to a server the device information and administrator information such that the plurality of devices are registered to the server.

According to an example embodiment, the instructions may further cause the processor to receive from the server a registration request, transmit the registration request to the plurality of devices, receive a registration response from the plurality of device, and transmit the registration response to the server such that the plurality of devices are registered to the server.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a block diagram of an image forming apparatus according to an example embodiment.

FIG. 2 is a block diagram of a cloud service providing system according to an example embodiment.

FIG. 3 illustrates a server and a plurality of devices, according to an example embodiment.

FIG. 4 illustrates a server, a plurality of devices, and an intermediate device, according to an example embodiment.

FIG. 5 illustrates a flowchart of a method of registering a plurality of devices to a server by using an intermediate device, according to an example embodiment.

FIG. 6 illustrates device information which is collected from a plurality of devices by an intermediate device.

FIG. 7 illustrates device information used for registering a plurality of devices to a server, according to an example embodiment.

FIG. 8 illustrates graphic user interfaces (GUIs) for collecting device information and registering a plurality of devices.

FIG. 9 illustrates a flowchart of a method of registering a plurality of devices to a server based on a registration status, according to an example embodiment.

FIG. 10 illustrates GUIs for registering a plurality of devices to a server based on a registration status, according to an example embodiment.

### DETAILED DESCRIPTION

Reference will now be made in detail to embodiments, examples of which are illustrated in the accompanying drawings. In this regard, the embodiments may have different forms and should not be construed as being limited to the descriptions set forth herein. In order to further clearly describe features of the embodiments, descriptions of other features that are well known to one of ordinary skill in the art are omitted herein.

In the specification, when an element is “connected” to another element, the elements may not only be “directly connected”, but may also be “electrically connected” via another element therebetween. It should be understood that the terms “comprises,” “comprising,” “including,” and “having” are inclusive and therefore specify the presence of stated features or components, but do not preclude the presence or addition of one or more other features or components.

In the disclosure, the electronic device may be a smartphone, tablet, personal digital assistant (PDA), media player, portable multimedia player, e-book reader, digital broadcast device, personal computer (PC), laptop computer, micro server, navigation device, MP3 player, digital camera, mobile device, or image forming apparatus, but is not limited thereto.

In the specification, an “image forming job” may denote any one of various jobs (for example, printing, copying, scanning, and faxing) related to an image, such as forming of an image or generating/storing/transmitting of an image file, and a “job” may denote not only an image forming job, but may also denote a series of processes required to perform the image forming job.

Also, an “image forming apparatus” may denote any apparatus capable of performing an image forming job, such as a printer, a scanner, a fax machine, a multi-function printer (MFP), or a display apparatus.

A hard copy may denote an operation of printing an image on a printing paper. A soft copy may denote an operation of outputting an image on a display such as a television or monitor.

Also, “content” may denote any type of data that is a target of an image forming job, such as a picture, an image, or a document file.

Also, “print data” may denote data having a format printable by a printer. In this case, “content” may include content having a format printable by a printer. For example, printing content may denote that content having a print data format is printed.

Also, a “scan file” may denote a file generated by scanning an image by using a scanner.

Also, a “user” may denote a person who performs manipulation related to an image forming job by using an image forming apparatus or a device connected to the image forming apparatus wirelessly or via wires. Also, an “administrator” may denote a person who has authorization to access every function of the image forming apparatus. The administrator may be a user, and vice versa.

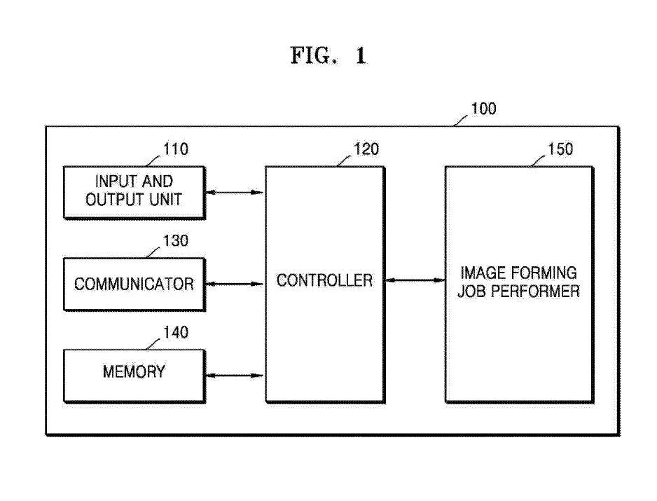

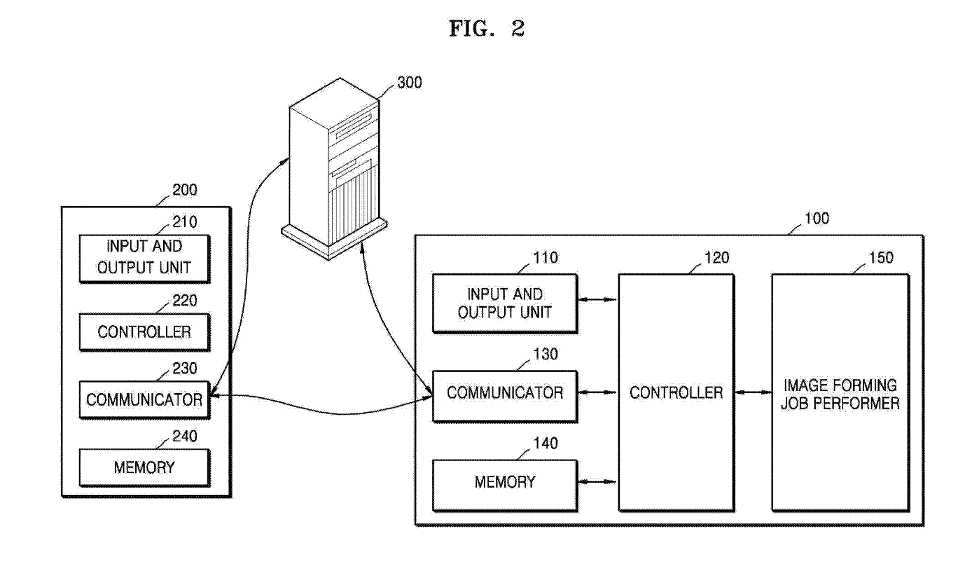

FIG. 1 is a block diagram of an image forming apparatus according to an example embodiment. The block diagram of the image forming apparatus according to an embodiment will be described by further referring to FIG. 2.

FIG. 2 is a block diagram of a cloud service providing system according to an example embodiment.

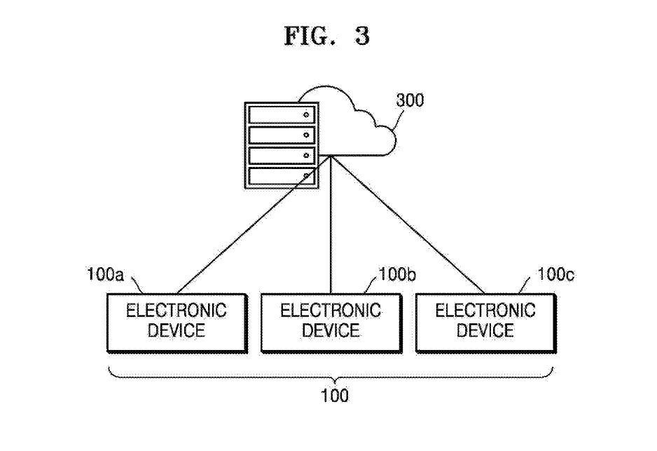

FIG. 1 illustrates components of the image forming apparatus according to an embodiment. Referring to FIG. 1, the image forming apparatus 100 according to an embodiment may include an input and output unit 110, a controller 120, a communicator 130, a memory 140, and an image forming job performer 150. The image forming apparatus 100 may be one of a plurality of devices which will be described later by referring to FIGS. 3, 4, 5, 6, 7, 8, 9, and 10. Also, although not illustrated in FIG. 1, the image forming apparatus 100 may further include a power supplier for supplying power to each component of the image forming apparatus 100.

The input and output unit 110 may include an input unit for receiving, from a user, an input for performing an image forming job, and an output unit for displaying information, such as a result of performing an image forming job or a state of the image forming apparatus 100. For example, the input and output unit 110 may include an operation panel for receiving a user input and a display panel for displaying a screen.

In detail, the input unit may include at least one of devices for receiving various types of user inputs, such as a keyboard, a physical button, a touch screen, a camera, and a microphone. Also, the output unit may include, for example, a display panel or a speaker. However, an embodiment is not limited thereto, and the input and output unit 110 may include at least one device supporting various inputs and outputs.

The controller 120 controls overall operations of the image forming apparatus 100, and may include a processor, such as a central processing unit (CPU). The controller 120 may control other components included in the image forming apparatus 100 such that an operation corresponding to a user input received through the input and output unit 110 is performed.

For example, the controller 120 may execute a program stored in the memory 140, read a file stored in the memory 140, or store a new file in the memory 140.

The communicator 130 may communicate with another device or a network in a wired or wireless manner. Accordingly, the communicator 130 may include a communication module supporting at least one of various wired and wireless communication methods. For example, the communication module may be in a form of a chipset or may be a sticker or a barcode (for example, a sticker including a near field communication (NFC) tag) including information required for communication.

Wireless communication may include, for example, at least one of wireless fidelity (Wi-Fi), W-Fi direct, Bluetooth, ultra wideband (UWB), and NFC. Wired communication may include, for example, at least one of universal serial bus (USB) and high definition multimedia interface (HDMI).

The communicator 130 may be connected to an external apparatus 200 provided outside the image forming apparatus 100 to transmit and receive a signal or data to and from the external apparatus 200. Referring to FIG. 2, the image forming apparatus 100 is connected to the external apparatus 200 through the communicator 130. The communicator 130 may transmit a signal or data received from the external apparatus 200 to the controller 120, or transmit a signal or data generated by the controller 120 to the external apparatus 200. For example, when the communicator 130 receives a print command signal or print data from the external apparatus 200, the controller 120 may output the print data to the image forming job performer 150.

As shown in FIG. 2, the external apparatus 200 may include an input and output unit 210, a controller 220, a communicator 230, and a memory 240. The external apparatus 200 may be an intermediate device which will be described later by referring to FIGS. 3, 4, 5, 6, 7, 8, 9, and 10. The controller 220 may control an image forming job by executing a program stored in the memory 240 and transmitting a signal or data generated as a result of executing the program to the image forming apparatus 100 through the communicator 230. The external apparatus 200 may be, for example, a smart phone, a tablet PC, a PC, an electronic device, a medical device, a camera, or a wearable device.

Meanwhile, the communicator 130 may be directly connected to a server 300 so as to transmit and receive a signal or data to and from the server 300. The server 300 may be a server which will be described later by referring to FIGS. 3, 4, 5, 6, 7, 8, 9, and 10. Also, the communicator 130 may be connected to the external apparatus 200 through the server 300. In other words, the communicator 130 of the image forming apparatus 100 may transmit and receive a signal or data to and from the communicator 230 of the external apparatus 200 through the server 300.

Referring back to FIG. 1, various types of data, such as a file or a program like an application, may be installed and stored in the memory 140. The controller 120 may access the data stored in the memory 140 to use the data, or may store new data in the memory 140. Also, the controller 120 may execute the program installed in the memory 140. Also, the controller 120 may install an application, which is received from an external source through the communicator 130, in the memory 140.

The image forming job performer 150 may perform an image forming job, such as printing, scanning, or faxing.

FIG. 3 illustrates a server and a plurality of devices, according to an example embodiment.

A plurality of devices 100 may be registered to a server 300, and services provided by the server 300 may be used in the plurality of devices 100. The server 300 may be a cloud server 300, and may include a plurality of servers.

An administrator of the plurality of devices 100 may access the server 300 through each device 100a, 100b, or 100c to register it to the server 300.

When the number of the devices 100 which are managed by the administrator exceeds a certain number or the devices are located in different places, it may be time consuming and cause an increase in network traffic to access the server 300 at each of the devices 100.

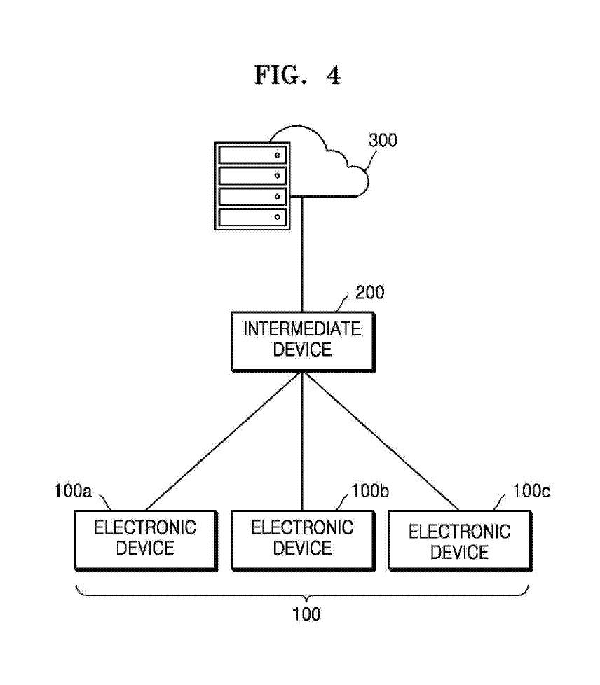

FIG. 4 illustrates a server, a plurality of devices, and an intermediate device, according to an example embodiment.

An administrator of the plurality of devices 100 may access the server 300 through an intermediate device 200 to register it to the server 300.

The intermediate device 200 may be connected to the devices 100 through a network. The intermediate device 200 and the devices 100 may be connected to each other in a home network, and may form a network with each other based on digital living network alliance (DLNA). The intermediate device 200 and the devices 100 may be connected by a wireless or wired communication interface as described above.

The intermediate device 200 may search for the devices 100 which are connected to the intermediate device 200 via a network. The intermediate device 200 may search for the devices 100 communicating based on a certain protocol. For example, the devices 100 may communicate based on universal plug and play (UPnP), but are not limited thereto.

In an example embodiment, the intermediate device 200 may search a network for the devices 100 which are connected to the intermediate device 200. The intermediate device 200 may search the network by broadcasting. For example, the intermediate device 200 may transmit a ping or any message to addresses available on the network to search for the devices 100 which respond to the transmitted ping or message. In an example embodiment, the intermediate device 200 may search a certain subnet of the network for the devices 100. The intermediate device 200 may search the subnet by broadcasting.

In an example embodiment, the intermediate device 200 may search the network by performing an internet protocol (IP) range search.

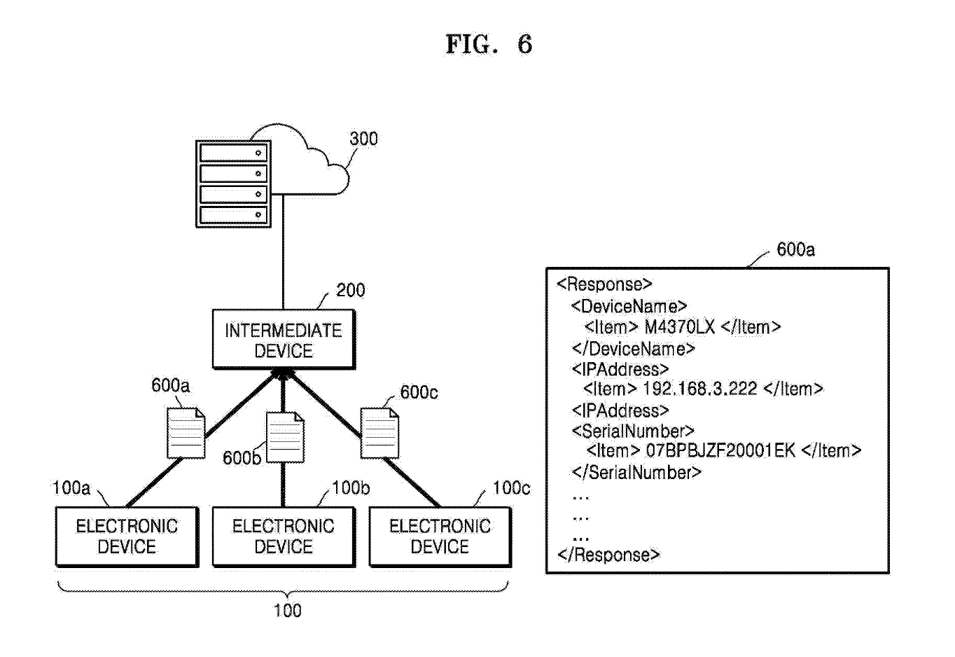

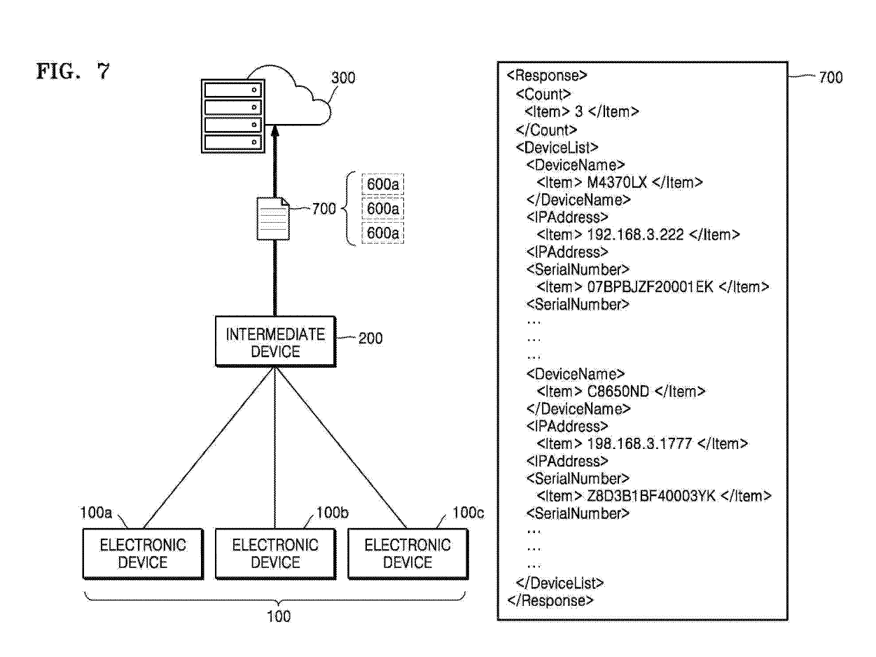

The intermediate device 200 may collect device information from the devices 100 which are found by the intermediate device 200. The device information collected from the devices 100 will be described later by referring to FIGS. 6 and 7.

The server 300 may register the devices 100 to the server in response to receiving the device information of the devices 100 collected by the intermediate device 200. Therefore, network traffic between the devices 100 and the server may be reduced according to an example embodiment. An administrator of the devices 100 may collectively register the devices 100 to the server without accessing the server at each of the devices 100.

In an example embodiment, the server 300 may transmit to the intermediate device 200 a device search request. The intermediate device 200 may search for the devices 100 in response to the device search request. The device search request may be transmitted from the server 300 to the intermediate device 200 by an administrator. For example, the administrator may access the server 300 via the intermediate device 200 to cause the server 300 to transmit the device search request to the intermediate device 200. The administrator may access the server 300 via a device other than the intermediate device 200 to cause the server 300 to transmit the device search request to the intermediate device 200.

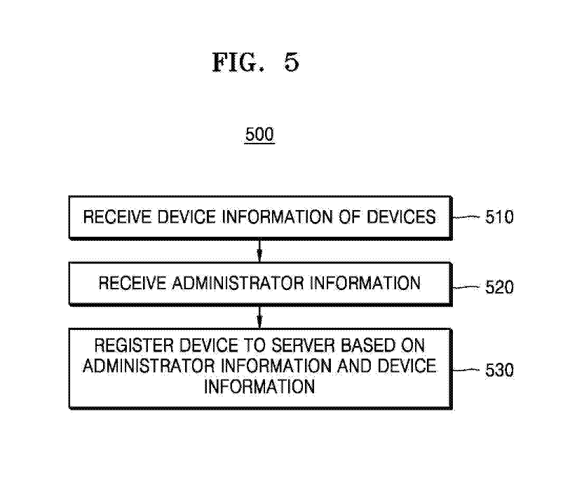

FIG. 5 illustrates a flowchart of a method of registering a plurality of devices to a server by using an intermediate device, according to an example embodiment.

A method 500 of registering a plurality of devices to a server may include receiving device information of the plurality of devices at the server in operation 510, receiving administrator information at the server in operation 520, and registering the plurality of devices to the server based on the device information and the administrator information in operation 530.

In operation 510, the server may receive device information of the plurality of devices. The server may include a plurality of servers.

The device information of the plurality of devices may be collected through an intermediate device. The device information of the plurality of devices may be created by collecting a piece of device information from each of the plurality of devices.

In an example embodiment, the device information may be transmitted from the intermediate device to the server. For example, the intermediate device may search for the plurality of devices which are connected to the intermediate device, collect the device information from the plurality of devices, and transmit the device information to the server.

In an example embodiment, the device information may be transmitted to the server from a device other than the intermediate device. For example, the device information collected by the intermediate device may be stored in a recording medium, or transmitted to another device, and the other device may transmit the device information to the server. When a first intermediate device collects device information from a first plurality of devices which are connected to the first intermediate device via a first network and a second intermediate device collects device information from a second plurality of devices which are connected to the second intermediate device via a second network, the first intermediate device may transmit the device information of the first plurality of devices to the second intermediate device. Therefore, the first plurality of devices and the second plurality of devices may be collectively registered to the server by transmitting the device information of the first and second plurality of devices from the second intermediate device to the server.

In an example embodiment, the server may receive device information via a communication interface of the server or another server.

In operation 520, the server may receive administrator information.

The administrator information may be used to identify an administrator managing the plurality devices. The administrator information may include information about an ID, password, or biological information of the administrator, but is not limited thereto.

In an example embodiment, the administrator information may be input at the intermediate device, and then transmitted from the intermediate device to the server.

In an example embodiment, the administrator information may be input at a device other than the intermediate device, and then transmitted from the other device to the server. When a first intermediate device collects device information from a first plurality of devices which are connected to the first intermediate device via a first network and a second intermediate device collects device information from a second plurality of devices which are connected to the second intermediate device via a second network, the first intermediate device may transmit the device information of the first plurality of devices to the second intermediate device. Therefore, the first plurality of devices and the second plurality of devices may be collectively registered to the server by transmitting the device information of the first and second plurality of devices and the administrator information from the second intermediate device to the server.

In an example embodiment, the server may receive administrator information via a communication interface of the server or another server.

In operation 530, the server may register the plurality of devices to the server based on the device information and the administrator information.

The server may create registration information of the plurality of devices to register the plurality of devices to the server.

In an example embodiment, the registration information of the plurality of devices may be stored in a database of the server so that registration of the plurality of devices to the server may be completed. In an example embodiment, the stored registration information may be transmitted from the server to the plurality of devices. A registration result may be displayed on each of the plurality of devices based on the registration information transmitted from the server. According to an example embodiment, the plurality of devices may be collectively registered to the server without accessing the server at each of the plurality of devices.

In an example embodiment, the created registration information may be transmitted from the server to the plurality of devices via the intermediate device. The registration information transmitted may include a registration request for registering the plurality of devices to the server. The plurality of devices may transmit a registration response to the server in response to receiving the registration request. The server may store the registration information of the plurality of devices in a database of the server in response to receiving registration responses from the plurality of devices so that registration of the plurality of devices to the server may be completed. Devices that respond to the registration request may be registered to the server. Therefore, devices that are capable of communicating with the server may be registered to the server.

In an example embodiment, each of the plurality of devices may include an agent for displaying a registration result, receiving a registration request, and transmitting a registration response in response to the registration request.

FIG. 6 illustrates device information which is collected from a plurality of devices by an intermediate device.

Device information of a plurality of devices may be collected by an intermediate device. As illustrated in FIG. 6, device information 600a, 600b and 600c may be transmitted from devices 100a, 100b, and 100c to an intermediate device 200. In an example embodiment, the devices 100a, 100b, and 100c may transmit their device information 600a, 600b, and 600c to the intermediate device 200 in response to a search by the intermediate device 200.

The device information 600a, 600b, and 600c may be used to identify the devices 100a, 100b, and 100c. The device information 600a, 600b, and 600c may include information about device names, IDs, serial numbers, security IDs, media access control (MAC) addresses, universally unique identifiers (UUIDs) of the devices 100a, 100b, and 100c.

In an example embodiment, each of the devices 100a, 100b, and 100c may include an agent for responding to a search of the intermediate device 200.

FIG. 7 illustrates device information used for registering a plurality of devices to a server, according to an example embodiment.

The device information 600a, 600b, and 600c collected by the intermediate device 200 may be combined together by the intermediate device 200. The combined device information 700 may be transmitted from the intermediate device to the server as illustrated in FIG. 7.

In an example embodiment, the combined device information 700 may be transmitted to the server 300 from a device other than the intermediate device 200. For example, the device information collected by the intermediate device 200 may be stored in a recording medium, or transmitted to another device, and the other device may transmit the device information to the server 300. When a first intermediate device collects device information from a first plurality of devices which are connected to the first intermediate device via a first network and a second intermediate device collects device information from a second plurality of devices which are connected to the second intermediate device via a second network, the first intermediate device may transmit the device information of the first plurality of devices to the second intermediate device. Therefore, the first plurality of devices and the second plurality of devices may be collectively registered to the server 300 by transmitting the device information of the first and second plurality of devices and the administrator information from the second intermediate device to the server 300.

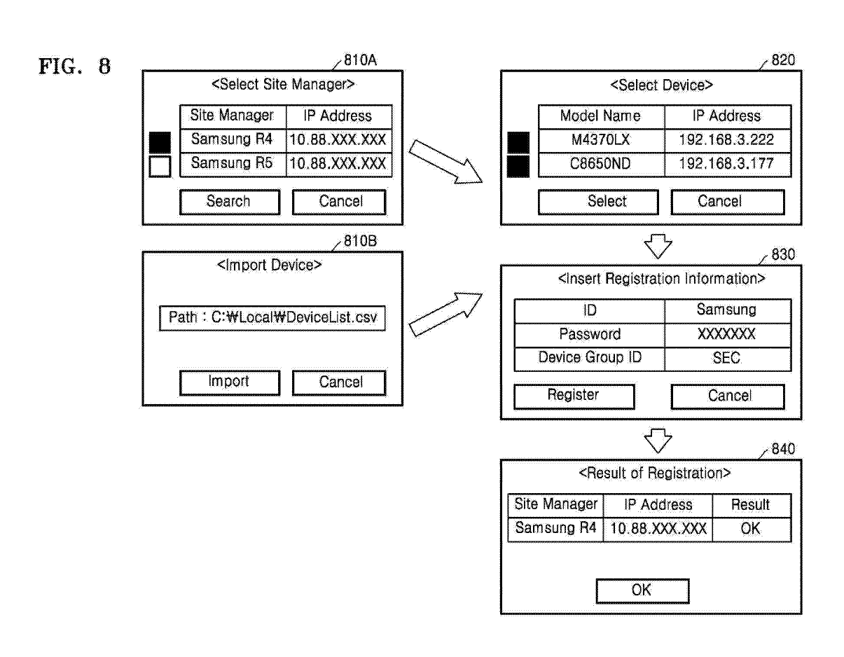

FIG. 8 illustrates graphic user interfaces (GUIs) for collecting device information and registering a plurality of devices.

In an example embodiment, the server may transmit to the intermediate device a device search request. The intermediate device may search for the devices in response to the device search request. The device search request may be transmitted from the server to the intermediate device by an administrator. For example, the administrator may access the server via the intermediate device to cause the server to transmit the device search request to the intermediate device. The administrator may access the server via a device other than the intermediate device to cause the server to transmit the device search request to the intermediate device.

For example, as illustrated in FIG. 8, a user interface (UI) 810A for selecting an intermediate device to which is to be transmitted, from the server, the device search request, may be provided to the administrator. Referring to FIG. 8, the device search request may be transmitted to an intermediate device of “Samsung R4/10.88.XXX.XXX.”

In an example embodiment, the device information of the plurality of devices may be collected by the intermediate device, and may be generated by combining device information of each device. Referring to FIG. 8, a UI 810B for uploading the device information to the server may be provided to the administrator.

The device information may have a certain format such as comma-separated values (CSV), tab-separated values (TSV), space-separated values (SSV), and a spreadsheet, but is not limited thereto.

Referring to FIG. 8, the administrator may upload device information of “C:\Local\DeviceList.csv” to the server. The device information may be stored in a local folder of a device of the administrator. The device of the administrator may be the intermediate device, but is not limited thereto, and may be a device other than the intermediate device.

In an example embodiment, a UI for selecting a method of registration may be provided to the administrator, and may be displayed on the intermediate device, or a device other than the intermediate device. For example, whether to use device information which is pre-generated by combining device information of each device, or further to search for a device by transmitting the device search request to the intermediate device may be provided as methods of registration.

A UI 820 for selecting at least one device among the plurality of devices may be provided to the administrator based on the device information. Referring to FIG. 8, devices of “M4370LX” and “C8750ND” connected to the intermediate device of “Samsung R4/10.88.XXX.XXX” may be selected.

In an example embodiment, the administrator may insert a group ID for the selected devices. Therefore, the administrator may manage the plurality of devices in one or more groups.

After at least one device is selected to be registered to the server, a UI 830 for inputting the administrator information may be provided to the administrator. Referring to FIG. 8, a ID of “Samsung” and a password of “XXXXXXX” may be input as the administrator information. The group ID may be editable in the UI 830.

The server may register the devices of “M4370LX” and “C8750ND” to the server based on the device information and the administrator information. A UI 840 for displaying a registration result may be provided to the administrator. The UIs 810A, 810B, 820, 830, and 840 may be displayed on the intermediate device or a device other than the intermediate device.

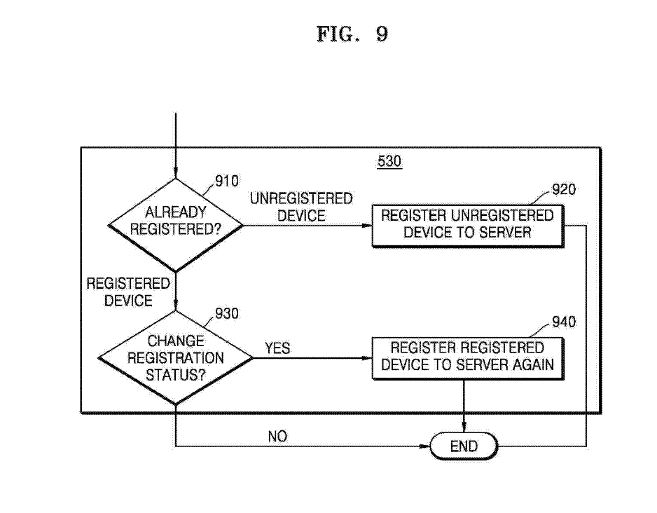

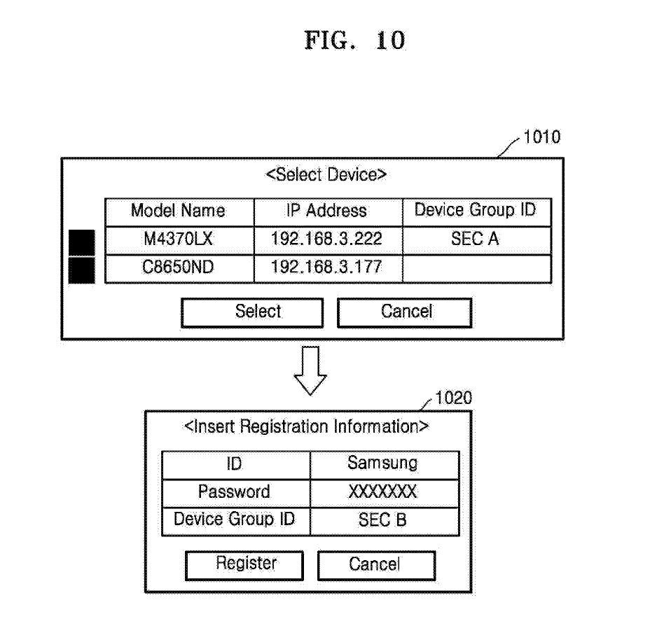

FIG. 9 illustrates a flowchart of a method of registering a plurality of devices to a server based on a registration status, according to an example embodiment. The flowchart of FIG. 9 will be described below by further referring to FIG. 10.

FIG. 10 illustrates GUIs for registering a plurality of devices to a server based on a registration status, according to an example embodiment.

In operation 910, the server may determine whether the plurality of devices are already registered to the server before registering them to the server.

In operation 920, the server may register an unregistered device to the server.

In operation 930, the server may receive an input from the administrator to change a registration status of a registered device.

In operation 940, the server may register the registered device again in response to receiving the input to change the registration status in operation 930. Therefore, a group to which the registered device belongs may be changed.

A UI 1010 for selecting at least one device among the plurality of devices may be provided to the administrator based on the device information. Referring to FIG. 10, a device of “M4370LX” may be a registered device belonging to a group of “SEC A”, and a device of “C8650ND” may be an unregistered device.

As illustrated in FIG. 10, a UI 1020 for inputting a group ID and administrator information may be provided to the administrator, and may be displayed on the intermediate device and/or a device other than the intermediate device. Referring to FIG. 10, the unregistered device of “C8650ND” and the registered device “M4370LX” may be registered to the server as a group of “SEC B”

FIG. 10 is illustrated as both the unregistered device and the registered device being selected to be registered to the server, but either one of them may be selected to be registered, or none of them may be registered by selecting a cancel menu.

When both the unregistered device and the registered device are selected to be registered to the server as a group of “SEC B”, only the unregistered device may be registered to the server since the registered device already belongs to the group of “SEC B.”

FIG. 10 is illustrated as the registered device being shown in the UI 1010, but the registered deice may not be displayed in the UI 1010 according to an embodiment. Therefore, the administrator may register an unregistered device to the server efficiently.

The embodiments described above may be embodied as computer-readable codes on a computer-readable recording medium storing commands and data executable by a computer. The computer-readable recording medium may be a non-transitory computer-readable recording medium. At least one of the commands and the data may be stored in a form of a program code, and may perform an operation by generating a program module when executed by a processor.

Examples of non-transitory computer-readable recording media include magnetic storage media (e.g., ROM, floppy disks, hard disks, etc.), optical recording media (e.g., CD-ROMs, or DVDs), memories included in a server accessible through a network, etc. For example, the non-transitory computer-readable recording medium may be at least one of the memory 140 of the image forming apparatus 100 or a memory of the input and output unit 110 that is configured as an independent control system. Alternatively, the non-transitory computer-readable recording medium may be the memory 240 included in the external apparatus 200 connected to the image forming apparatus 100 through a network.

Although a few embodiments have been shown and described, it would be appreciated by those skilled in the art that changes may be made in these embodiments without departing from the principles and spirit of the disclosure, the scope of which is defined in the claims and their equivalents.

What is claimed is:

1. A computer-implemented method, comprising:
receiving, at a server, device information of a plurality of devices, the device information being collected by an intermediate device;
receiving, at the server, administrator information; and
registering the plurality of devices to the server based on the received administrator information and the received device information.

2. The computer-implemented method of claim 1, wherein
the plurality of devices are discovered by the intermediate device, and
the device information is collected by the intermediate device from the discovered plurality of devices.

3. The computer-implemented method of claim 2, wherein the method further comprises:
transmitting a device search request to the intermediate device, wherein
the plurality of devices are discovered by the intermediate device receiving the transmitted device search request.

4. The computer-implemented method of claim 1, wherein the device information is uploaded to the server by an administrator.

5. The computer-implemented method of claim 1, wherein the registering of the plurality of devices comprises:
determining whether the plurality of devices are already registered to the server, and
registering to the server an unregistered device from among the plurality of devices based on the received administrator information and the received device information.

6. The computer-implemented method of claim 1, wherein the registering of the plurality of devices comprises:
determining whether the plurality of devices are already registered to the server, and
changing a registration status of a registered device from among the plurality of devices.

7. The computer-implemented method of claim 1, wherein the registering of the plurality of devices comprises:
transmitting to the plurality of devices a registration request for registering the plurality of devices to the server based on the received administrator information and the received device information,
receiving from the plurality of devices a registration response transmitted in response to the registration request, and
registering the plurality of devices to the server based on the received registration response.

8. The computer-implemented method of claim 7, wherein at least one of the registration request and the registration response is communicated by the intermediate device.

9. A system, comprising:
a memory configured to store instructions; and
at least one processor configured to execute the instructions to:
receive device information, collected by an intermediate device, of a plurality of devices,
receive administrator information, and
register the plurality of devices to the system based on the received administrator information and the received device information.

10. The system of claim 9, wherein
the plurality of devices are discovered by the intermediate device, and
the device information is collected by the intermediate device from the discovered plurality of devices.

11. The system of claim 10, wherein
the processor is further configured to execute the instructions to transmit a device search request to the intermediate device, and
the plurality of devices are discovered by the intermediate device in response to the intermediate device receiving the transmitted device search request.

12. The system of claim 10, wherein the device information is uploaded to the system by an administrator.

13. The system of claim 9, wherein the processor is further configured to execute the instructions to:
determine whether the plurality of devices are already registered to the system, and
register to the system an unregistered device among the plurality of devices based on the received administrator information and the received device information.

14. The system of claim 9, wherein the processor is further configured to execute the instructions to:
determine whether the plurality of devices are already registered to the system, and
change a registration status of a registered device among the plurality of devices.

15. The system of claim 9, wherein the processor is further configured to execute the instructions to:
transmit to the plurality of devices a registration request for registering the plurality of devices to the system based on the received administrator information and the received device information,
receive from the plurality of devices a registration response transmitted in response to the registration request, and
register the plurality of devices to the system based on the received registration response.

16. The system of claim 9, wherein at least one of the registration request and the registration response is communicated by the intermediate device.

17. A non-transitory computer readable recording medium having recorded thereon instructions, which when executed by a processor, cause the processor to carry out the computer-implemented method of claim 1.

18. A non-transitory computer readable recording medium having thereon instructions, which when executed by a processor, cause the processor to:
collect device information from a plurality of devices; and
transmit to a server the device information and administrator information such that the plurality of devices are registered to the server.

19. The non-transitory computer readable recording medium of the claim 18, wherein the instructions further cause the processor to:
receive from the server a registration request;
transmit the registration request to the plurality of devices,
receive a registration response from the plurality of device, and
transmit the registration response to the server such that the plurality of devices are registered to the server.

20. The non-transitory computer readable recording medium of the claim 18, wherein the plurality of devices are discovered by an electronic device in response to the electronic device receiving a device search request from the server.
